(19) United States
(12) Patent Application Publication
(10) Pub. No.: US 2003/0025354 A1
(43) Pub. Date: Feb. 6, 2003

(54) Vehicular window covering

(76) Inventors: Femi Akintan, Staten Island, NY (US); Ibikunle Yusuf, Staten Island, NY (US)

Correspondence Address: Matthew J. Peirce, Esq., 1550 Starlight Canyon Avenue, Las Vegas, NV, 89123, US

(21) Appl. No.: 09/922,303

(22) Filed: Aug. 6, 2001

(51) Int. Cl. B60J 1/17

(52) U.S. Cl. 296/146.16; 49/63

(57) ABSTRACT

A new and improved apparatus is disclosed that will allow a driver of a vehicle the option of having a tinted window or a regular window present at one or more windows in a particular vehicle. The present invention would equip an automobile or other vehicle with a second, tinted window which would allow a user to choose between the regular window, which would remain present, and the tinted window. Each of the two windows would be positioned parallel to one another and operate on parallel, separate tracks. The windows each operate similar to that of a standard power window, with a switch being present for each window. A user would choose to use either the standard window or the tinted window based on existing state laws, weather conditions, and personal preferences.

### I. BACKGROUND OF THE INVENTION

The present invention concerns that of a new and improved apparatus that will allow a driver of a vehicle the option of having a tinted window or a regular window present at one or more windows in a particular vehicle.

### II. DESCRIPTION OF THE PRIOR ART

U.S. Pat. No. 5,165,188, issued to Tsiros, discloses a window tinting apparatus which is arranged for adjustment relative to a vehicular door adjacent an existing window of the associated vehicle.

U.S. Pat. No. 4,943,103, issued to Rosen, discloses a shield for protecting the driver of a vehicle against reflected glare from an exterior mirror.

### III. SUMMARY OF THE INVENTION

The present invention concerns that of a new and improved apparatus that will allow a driver of a vehicle the option of having a tinted window or a regular window present at one or more windows in a particular vehicle. The present invention would equip an automobile or other vehicle with a second, tinted window which would allow a user to choose between the regular window, which would remain present, and the tinted window. Each of the two windows would be positioned parallel to one another and operate on parallel, separate tracks. The windows each operate similar to that of a standard power window, with a switch being present for each window. A user would choose to use either the standard window or the tinted window based on existing state laws, weather conditions, and personal preferences.

There has thus been outlined, rather broadly, the more important features of a vehicular window covering in order that the detailed description thereof that follows may be better understood and in order that the present contribution to the art may be better appreciated. There are, of course, additional features of the vehicular window covering that will be described hereinafter and which will form the subject matter of the claims appended hereto.

In this respect, before explaining at least one embodiment of the vehicular window covering in detail, it is to be understood that the vehicular window covering is not limited in its application to the details of construction and to the arrangements of the components set forth in the following description or illustrated in the drawings. The vehicular window covering is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present vehicular window covering. It is important, therefore, that the claims be regard as including such equivalent constructions insofar as they do not depart from the spirit and scope of the present invention.

It is therefore an object of the present invention to provide a vehicular window covering which has all of the advantages of the prior art and none of the disadvantages.

It is another object of the present invention to provide a vehicular window covering which may be easily and efficiently manufactured and marketed.

It is another object of the present invention to provide a vehicular window covering which is of durable and reliable construction.

It is yet another object of the present invention to provide a vehicular window covering which is economically affordable and available to the buying public.

It is yet another object of the present invention to provide a vehicular window covering which provides additional benefits not present in the prior art.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a perspective view of the present invention.

FIG. 2 shows a top view of the two windows of the present invention.

FIG. 3 shows a side view of the two tracks of the present invention.

### V. DESCRIPTION OF THE PREFERRED EMBODIMENT

FIG. 1 shows a perspective view of the present invention. The present invention concerns that of a new and improved apparatus that will allow a driver of a vehicle the option of having a tinted window 2 or a regular window 4 in an “up” position at one or more windows in a particular vehicle. The present invention would equip an automobile 6 or other vehicle with a second, tinted window 2 which would allow a user to choose between the regular window 4, which would remain present, and the tinted window 2. Each of the two windows would be positioned parallel to one another and operate on parallel, separate tracks 8 and 10, with tinted window 2 operating on track 8 and standard window 4 operating on track 10. The windows each operate similar to that of a standard power window, with a pair of switches 12 and 14 available inside the vehicle, with switch 12 controlling the up and down movement of tinted window 2, while switch 14 would control the up and down movement of regular window 4.

Each window would have this configuration, as there may be more than one person inside a vehicle, with these different people possibly having different preferences. A user would choose to use either the standard window or the tinted window based on existing state laws, weather conditions, and personal preferences.

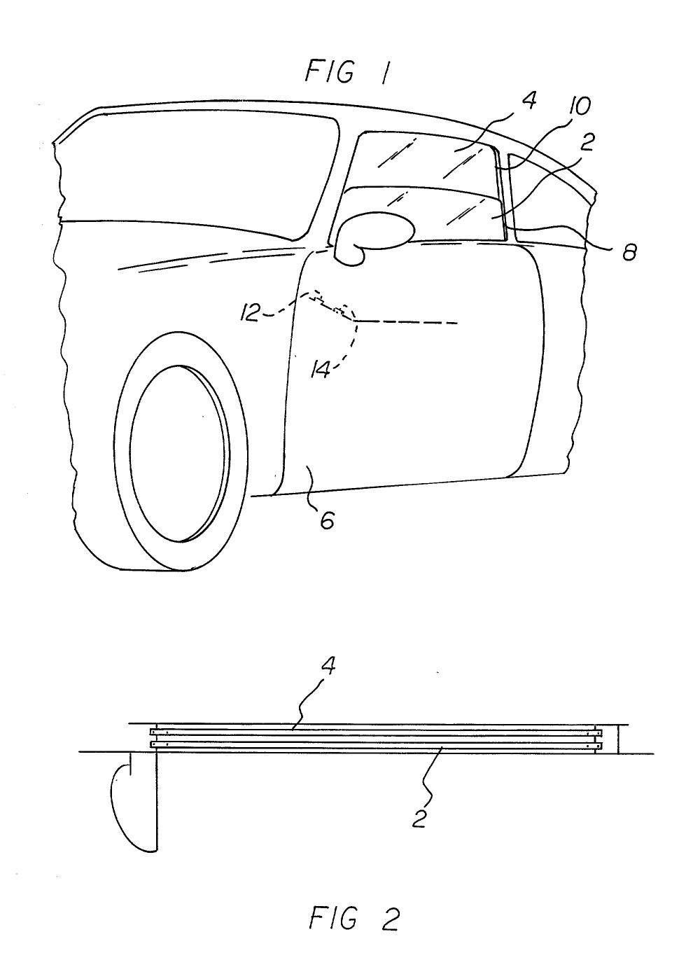

FIG. 2 shows a top view of the two windows of the present invention. In this configuration, tinted window 2 can be seen as the outer window compared to regular window 4. However, tinted window 2 could just as well be the inner window compared to regular window 4. No preference is generally given to whether tinted window 2 is the inner or outer window, as long as both tinted window 2 and regular window 4 are present at each window space on a vehicle.

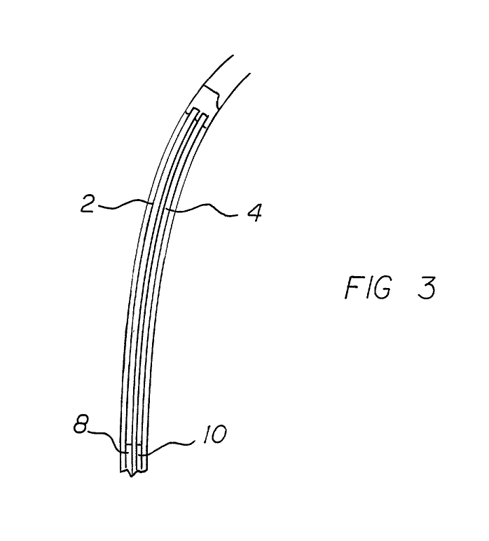

FIG. 3 shows a side view of tracks 8 and 10 of the present invention. As can be seen, tinted window 2 and regular window 4 run on separate tracks, with tinted window 2 running on track 8 and regular window 4 running on track 10.

What I claim as my invention is:

1. An apparatus for covering a window in a vehicle comprising:
(a) a first glass covering, the first glass covering capable of being opened and closed, the first glass covering being clear,
(b) a first track to hold and support the first glass covering,
(c) a second glass covering, the second glass covering capable of being opened and closed, the second glass covering being tinted, and
(d) a second track to hold and support the second glass covering.

2. An apparatus for covering a window in a vehicle according to claim 1 wherein the first glass covering would be the innermost glass covering on a particular window and the second glass covering would be the outermost glass covering on the particular window.

3. An apparatus for covering a window in a vehicle according to claim 1 wherein the first glass covering would be the outermost glass covering on a particular window and the second glass covering would be the innermost glass covering on the particular window.

4. An apparatus for covering a window in a vehicle according to claim 1 further comprising:
(a) a first electronic switch for controlling movement of the first glass covering, the first electronic switch located within a vehicle, and
(b) a second electronic switch for controlling movement of the second glass covering, the second electronic switch located within a vehicle.
